(19) United States
(12) Patent Application Publication
(10) Pub. No.: US 2007/0005490 A1
(43) Pub. Date: Jan. 4, 2007

(54) Methods and System for Distributed E-commerce

(76) Inventor: Kumar C. Gopalakrishnan, Mountain View, CA (US)

Correspondence Address: Kumar C. Gopalakrishnan, P.O. Box 2002, Mountain View, CA, 94042, US

(21) Appl. No.: 11/530,451

(22) Filed: Sep. 8, 2006

Related U.S. Application Data
(63) Continuation-in-part of application No. 11/215,601, filed on Aug. 30, 2005.
(60) Provisional application No. 60/715,979, filed on Sep. 9, 2005.
(60) Provisional application No. 60/606,282, filed on Aug. 31, 2004.

(51) Int. Cl. G06Q 40/00

(52) U.S. Cl. 705/37

(57) ABSTRACT

A system and methods for enabling e-commerce transactions on a distributed computer network comprised of mobile devices and computer systems is presented. The methods enable persistent and continued interaction with an e-commerce transaction across devices and over extended periods of time.

### CROSS-REFERENCE TO RELATED APPLICATIONS

This application claims the benefit of U.S. provisional patent applications 60/715,979, filed Sep. 9, 2005, and is a continuation-in-part of U.S. patent application Ser. No. 11/215,601, filed Aug. 30, 2005, which claims the benefit of U.S. provisional patent application 60/606,282, filed Aug. 31, 2004. These applications are incorporated by reference along with all other references cited in this application.

### BACKGROUND OF THE INVENTION

The present invention is related to performing electronic commerce transactions using computer systems. More specifically, the invention describes a system and methods for performing e-commerce transactions using mobile devices and computers connected by a network.

Systems for providing e-commerce transactions using mobile devices and computer systems exist. In some systems, the mobile device acts as a wallet. In this case, transactions are completed by using the mobile device to exchange credentials for completing a transaction with a Point Of Sale terminal using short range communication technologies such as Bluetooth. In other solutions, the mobile device is used to explicitly enter credentials for completing e-commerce transactions such as credit card information. For instance, a web browser integrated into a mobile device may be used to input credit card information for completing a transaction. This solution is similar to the typical mechanism provided for executing e-commerce transactions in a personal computer.

However, mechanisms for performing e-commerce transactions using both mobile devices and computer systems connected to each other over a network are in need.

### BRIEF SUMMARY OF THE INVENTION

The present invention describes a system and methods for enabling e-commerce transactions using mobile devices and computer systems connected by a network. E-commerce transactions may be initiated from one of the devices connected to the network and continued on another device. This enables persistent and ubiquitous access to e-commerce transactions. Further, e-commerce transactions may also be communicated by a user between devices in order to continue the transaction.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 illustrates the components of the system, in accordance with an embodiment.

FIG. 2(a) illustrates the components of an exemplary mobile device, in accordance with an embodiment.

FIG. 2(b) illustrates the components of an alternate view of a mobile device, in accordance with an embodiment.

FIG. 3 illustrates an exemplary process for initiating a distributed e-commerce transaction, in accordance with an embodiment.

FIG. 4(a) illustrates an exemplary user interface for presenting a continuity marker, in accordance with an embodiment.

FIG. 4(b) illustrates an alternate exemplary user interface for presenting a continuity marker, in accordance with an embodiment.

FIG. 5 illustrates an exemplary process for generating a continuity message, in accordance with an embodiment.

FIG. 6 illustrates an exemplary process for continued interaction with an e-commerce transaction communicated using a continuity message, in accordance with an embodiment.

FIG. 7 is a block diagram illustrating an exemplary computer system suitable for enabling distributed e-commerce transactions, in accordance with an embodiment.

### DETAILED DESCRIPTION OF THE INVENTION

A system and methods are described for enabling e-commerce over a distributed computer system comprising of computer systems and mobile devices. Various embodiments present mechanisms for providing e-commerce services over a distributed computer system. The specific embodiments described in this description represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” or “some embodiments” means that a particular feature, structure, or characteristic described in connection with the embodiment is included in at least one embodiment of the invention. The appearances of the phrase “in one embodiment” or “some embodiments” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

Various embodiments may be implemented in a computer system as software, hardware, firmware, or a combination of these. While the description below presents the full functionality of the invention, the mechanisms presented in the invention are configurable to the capabilities of the computer systems on which it is implemented, the resources available in the computer systems on which it is implemented and the requirements for providing the e-commerce services.

In the context of this description, the term “user interface element” refers to icons, text boxes, menus, graphical buttons, check boxes, sounds, animations, lists, and the like that constitute a user interface. The terms “widget” and “control” are also used to refer to user interface elements.

In the context of this description, the term “input component” refers to a component integrated into the system such as a key, button, joystick, touch pad, motion sensing device, speech input sensor, and the like that can be used to input information to the user interface. In the context of this description, the term “cursor control component” refers to a component integrated into the system such as a key, button, joystick, touch pad, motion sensing device, speech input sensor, and the like that can be used to control a cursor on the user interface. In the context of this description, the term “navigational component” refers to a component integrated into the system such as a key, button, joystick, touch pad, motion sensing device, speech input sensor, and the like that can be used to select, control, and switch between various user interface elements. In the context of this description, the term “menu command” refers to a command associated with a menu item on the user interface.

In the context of this description, the term “click” refers to the activation of an input component such as the pressing on a key, releasing a key, moving a joystick in one of its directions of motion, pressing the joystick, moving a scroll wheel in one of its directions of motion, activating a pressure sensitive input component on the mobile device or a combination thereof. The input of a click may or may not be associated with a widget presented on the user interface. For instance, in some embodiments, there may not be any widget (e.g., text or graphical element) associated with a key designated for activation of a continuity marker. In some embodiments, clicking may be achieved by tapping on a text or graphical widget on a touch-sensitive display. In some embodiments using a touch-sensitive display tapping anywhere on the display may be equivalent to inputting a click. In some embodiments, a click may be input using audio or visual inputs where spoken and visual commands are extracted from the audio and visual inputs respectively. In some embodiments, the motion of a portable device such as a mobile device may be used to represent the input of a click.

In the context of this description, the term “e-commerce transaction” includes transacting with online retailers such as an Internet retailer website, an Internet auction website, a comparison shopping website, XML based e-commerce services and the like. The transactions may include looking up product information such as price and features, comparing prices, providing personal and product details, sampling a product or service, making or receiving payments and the like. An e-commerce transaction may or may not include an accompanying financial transaction. For instance, an e-commerce transaction may include financial transactions for the purchase of a product or service. The purchased product may be a physical object such as a book or a non-physical object such as a digital music file. Further, the purchased service may be an online service such as a video rental subscription or a physical world service.

Exemplary System Architecture

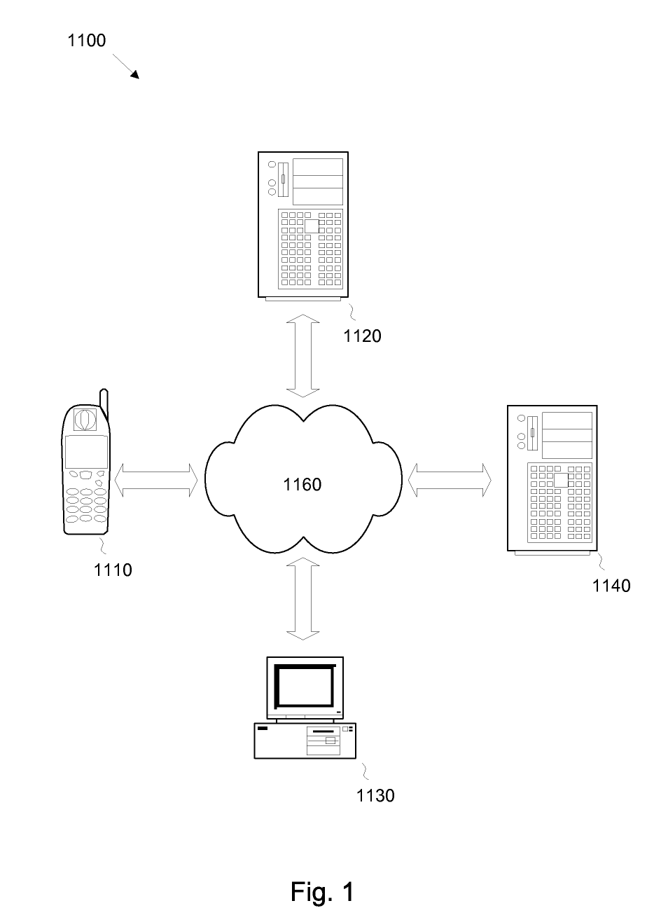

FIG. 1 illustrates the components of exemplary system 1100 comprised of mobile device 1110 and computer systems, system server 1120, remote computer 1130 and e-commerce server 1140 connected by communication network 1160.

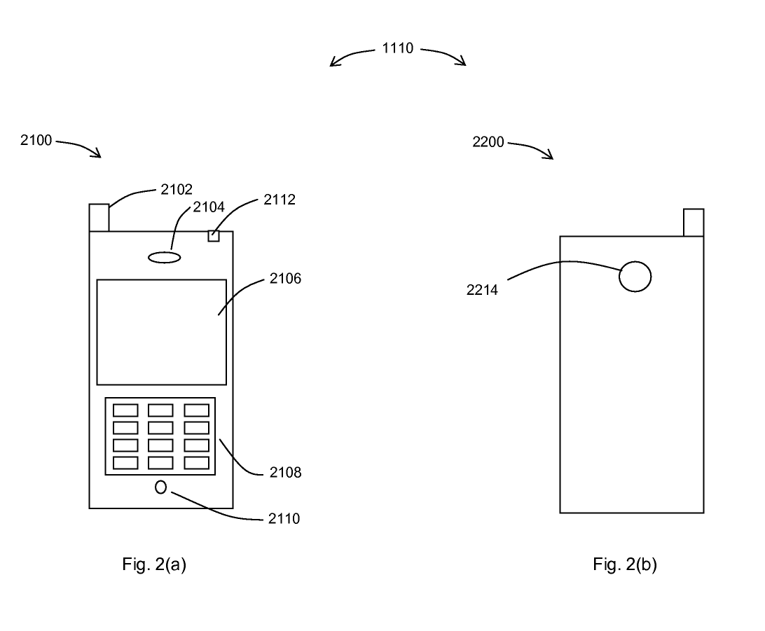

FIGS. 2(a) and 2(b) illustrate the components of an exemplary mobile device 1110 from which e-commerce transactions may be initiated, e.g., a cameraphone. Front view of cameraphone 2100 illustrated in FIG. 2(a) shows the communication antenna 2102, speaker 2104, display 2106, keypad 2108, microphone 2110 and visual indicator (e.g., LED) 2112. Rear view of cameraphone 2200 illustrated in FIG. 2(b) shows the integrated camera 2214. In some embodiments, the cameraphone may include other input components such as a joystick, thumbwheel, scroll wheel, touch sensitive panel, touch sensitive display, or additional keys. In some embodiments, the mobile device 1110 may be a gaming device, messaging device or PDA, or may be a distributed device where two or more physical devices work together over a network to provide the functionalities of the mobile device.

Mobile device 1110 may have a software component referred to as a client that is comprised of logic to realize the functions of executing an e-commerce transaction and a user interface. In the above description, the client is implemented as an independent module (e.g., software application) on the mobile device that provides the distributed e-commerce transaction functionality such as accepting requests for shopping information, generating the continuity message etc. In some embodiments, the same functionality may be realized using a web browser on the mobile device without an independent client module. In some embodiments, a part of the functionality of the client may be implemented as an independent client module and the other part implemented on a web browser on the mobile device. In some other embodiments, all the functionality of the client may be implemented with a web browser on the mobile device without an independent client module.

Remote computer 1130 may be a user's desktop personal computer, notebook computer or other computer system. E-commerce server 1140 may provide a plurality of information services by itself and in association with other e-commerce servers. Further, the e-commerce server may interface with other e-commerce services over a network such as the Internet. In some embodiments, the remote computer and e-commerce server may themselves be comprised of a network of computer systems as in the case of a server farm. Also, the interconnecting network may have several elements such as switches and routers that interconnect the components.

Communication network 1150 may be wireless, wired or a combination thereof. The wireless network may be any of the wireless data network such as GPRS, EDGE, UMTS, CDMA 1×, EV-DO, WiFi, WiMax and the like or their evolutions. The wired network may be implemented using technologies such as the Internet backbone, Ethernet, Firewire, Fiber Channel and the like.

System Operation

A distributed system for e-commerce transactions is implemented such that components of the transactions may be realized in various devices included in the distributed system. A user may begin an e-commerce transaction with one device and may continue it in parts with other devices. The devices used to continue the transaction may include the device used to start the transaction. The devices may communicate the information regarding the transaction and the state of the transaction to each other over the communication network. In some embodiments, communication among the devices may use a store-and-forward mode of communication such as email. In some embodiments, the communication among the devices may employ a direct mode of communication such as a peer-to-peer messaging network. Also, the communication network may incorporate intermediate devices that facilitate communication. For instance, when the transaction message is transported as an email, there may be one or more email servers incorporated into the communication network.

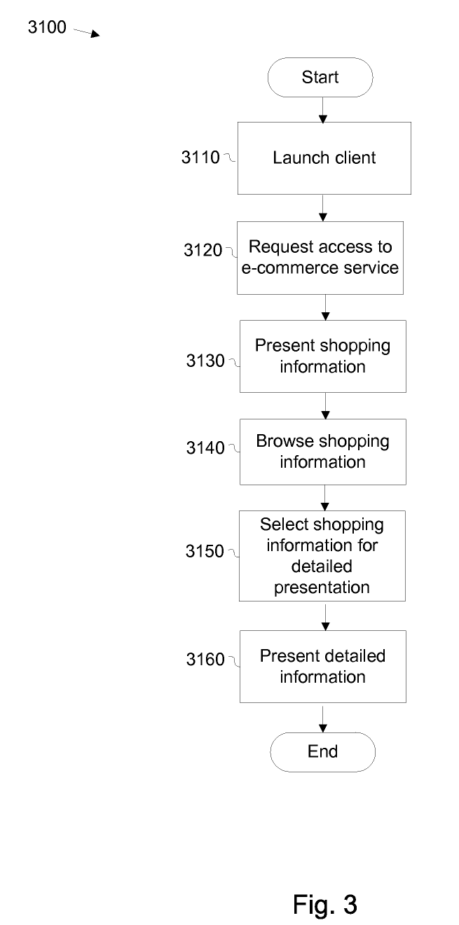

FIG. 3 illustrates an exemplary process 3100 for initiating a distributed e-commerce transaction. Process 3100 and other processes of this description may be implemented as a set of modules, which may be process modules or operations, software modules with associated functions or effects, hardware modules designed to fulfill the process operations, or some combination of the various types of modules. The modules of process 3100 and other processes described herein may be rearranged, such as in a parallel or serial fashion, and may be reordered, combined, or subdivided in various embodiments.

Here, a user begins using the distributed system by invoking a client on a mobile device 3110. The client may be a software application implemented using software platforms such as J2ME, S60™, Symbian™, Windows mobile™ or BREW™. The user may then request access to an e-commerce service 3120. For example, the user requests the client to provide shopping information on the mobile device. The user's request may be input by entering the product name, UPC code, brand name, manufacturer, model and the like into the client. In some embodiments, the request may also be in the form of visual imagery or audio data. In such instances, the system may analyze and interpret the visual imagery or audio data to identify relevant shopping information.

Upon receiving the request, the system responds with relevant shopping information which may then be presented on the client user interface 3130. In some embodiments, the response may be generated by the client on the mobile device by accessing the e-commerce server. In other embodiments, the request may be transmitted to a system server and a response may be generated on the system server and sent to the client based on the system server's interaction with the e-commerce server. The response is then presented to the user on the mobile device using the client user interface.

The shopping information presented may contain information relevant to one or more products or services. The user may browse through the shopping information 3140 and select one or more items to view in detail 3150. In a detailed view, the user may be able to view the product or service price, title, description, website address where the product or service may be purchased, the URL to the website, reviews, multimedia data such as audio or video segments and the like 3160.

In some embodiments, when a user queries for shopping information, a single relevant product information may be returned. In such case, the product details may be presented directly in a detailed view as there may not be a need to browse though a list of shopping information. In some embodiments, the user interface for presenting a plurality of products or services may include an auxiliary information pane for presenting product information such as title, price, etc, when a particular entry in the list is selected. In some embodiments, the client is capable of playing multimedia data such as an audio or video segment and includes controls appropriate for the presentation of the multimedia information. The multimedia data may be played when invoked by a user or automatically without user input.

Continuity Marker

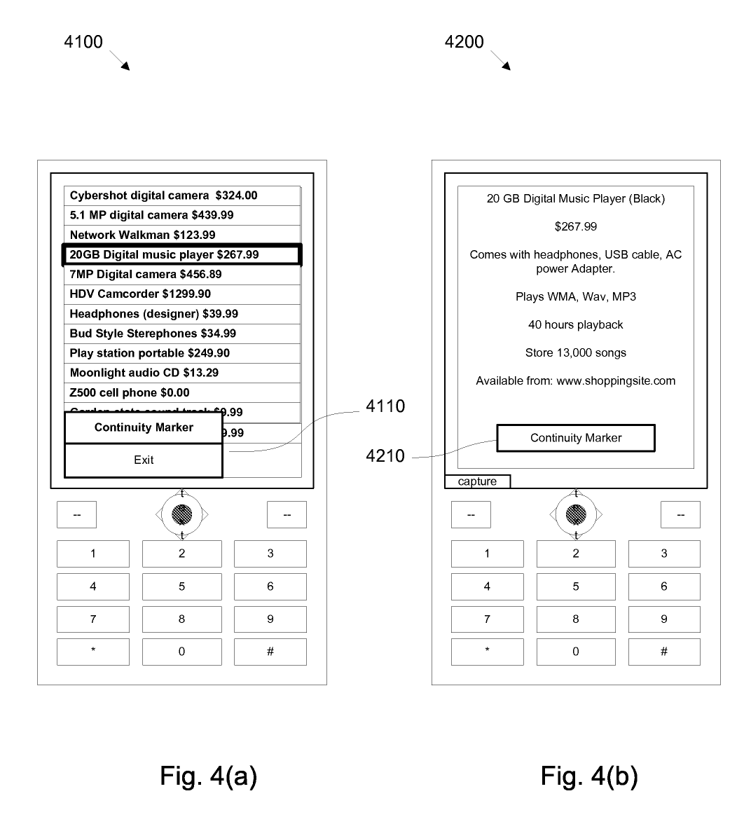

Information presented on the client user interface may include a continuity marker. The continuity marker identifies an e-commerce transaction that may be continued on another device. Upon activation of the continuity marker, the execution of the distributed e-commerce transaction may be continued on another device. A continuity marker may be represented visually on the user interface of the client in the form of a phrase of text such as “Buy from PC”, “Remind me at home”, “Continue Later”, or may be represented using audio such as a spoken phrase or a special audio tone. In some embodiments, the continuity marker may also be represented on the client user interface using an image, graphical icon, button or other graphical widgets that may be activated. In some embodiments, the continuity marker may not have a visual representation and may be activated by pressing a dedicated physical key on the mobile device. In some embodiments, the continuity marker may also be implemented as a graphical menu with associated soft keys. FIG. 4(a) illustrates an exemplary client user interface 4110 where the continuity marker is presented as a graphical menu 4110. FIG. 4(b) illustrates an exemplary client user interface where the continuity marker is presented as a graphical widget 4120.

In some embodiments, continuity markers may be presented while presenting a plurality of shopping information. In this case, the user may be able to select one among the plurality of information options and activate the associated continuity marker. In some embodiments, a user may send the entire list as part of the continuity message. FIG. 4(a) illustrates an exemplary client user interface 4110 where a continuity marker is presented in association with a plurality of information options.

In some embodiments, a continuity marker may be activated by a user using an input component integrated into the mobile device. In some embodiments, a continuity marker may be activated autonomously by the client. Further, the activation of a continuity marker may be accompanied by feedback on the user interface regarding the activation or the consequence of activation, in the form of visual or other signals.

The autonomous activation of a continuity marker by a client may be based on user preferences, the details of the e-commerce transaction such as product type, price etc, user's usage history, source of the e-commerce service and the like. For instance, when the user views the details of a certain product, there may not be any indication of the presence of a continuity marker on the client user interface, but, the client may automatically send a continuity message to another device. In some embodiments, the activation of the continuity marker by the client may be implemented in association with a system server. The functionality of activation of continuity marker by the client may be implemented partially or completely on the system server. For example, the system server may be configured such that when a user views certain shopping information on the mobile device, a continuity message may be sent by the system server to another device.

Continuity Message

A continuity message communicates the identity and state of an e-commerce transaction for continuation of the transaction on another device or at a later time. A continuity message may be comprised of the identity of an e-commerce transaction, its current state and associated data. For instance, a continuity message may include a session identifier, user inputs and information presented to the user as part of the transaction. Further, the continuity message may also include information related to an e-commerce transaction such as product unique identifier, product name, image, price, description, name of an e-commerce service, website or web page where the transaction could be completed, the URL corresponding to an e-commerce service, one or more hyperlinks to web sites and the like. A continuity message may also include multimedia data such as audio or video sequences. In some embodiments, a continuity message may also include a continuity marker to continue the e-commerce transaction from another device. In some embodiments, a continuation message may incorporate references to information (e.g. hyperlinks) in lieu of the actual information components described. A hyperlink included in a continuity message may be represented by a text string, an image or a combination thereof.

A continuity message is generated upon activation of a continuity marker. The continuity message may be transported through a communication service such as email, instant message, SMS or MMS. In some embodiments, a continuity message may also be transported in a proprietary format using proprietary protocols from one device to another. In the case of communication through email, the continuity message may be transported using well known protocols such as TCP, UDP, HTTP, SMTP, POP, IMAP and the like. In the case of communication through instant message, the continuity message may be transported using well known protocols such as TCP, UDP, HTTP, XMPP, SIMPLE, OMA-IMPP and the like.

In some embodiments, upon activation of a continuity marker, a continuity message may be sent without any further user inputs. In this case, the destination address such as email address or the instant messaging address may either be retrieved from the mobile device or from the system server. In some embodiments, upon activation of a continuity marker, the user may be prompted to enter the email address or the instant messaging address on the mobile device.

A continuity message may be routed through the system server or directly delivered to a destination from the mobile device without the intermediation of a system server. A continuity message routed through the system server may be communicated using a proprietary format or using a standard email or instant messaging format.

In some embodiments, a continuity message sent to a system server may be solely comprised of a user identifier and a session identifier. The system server may then lookup user preferences to determine the formatting and encoding of the continuity message for further forwarding (i.e., an email continuity message or an instant messaging continuity message), select the appropriate destination address, retrieve the state of the e-commerce transaction using the session identifier, format and encode the continuity message in the selected format, and deliver the continuity message. In some embodiments, if the continuity message cannot be delivered immediately, the system server may queue up the message and attempt delivery at a later time.

If the continuity message is encoded as an email message the system server may communicate it to the destination email server as a standard SMTP message. In some embodiments, a continuity message may be delivered through a computer system that is external to the present invention. For instance, a continuity message transported as an instant message may be delivered using an instant messaging server that is external to the present invention.

In some embodiments, upon delivery of the continuity message to a destination, the user may be provided feedback on the mobile device about the delivery of the continuity message. In some embodiments, feedback may be provided at the instant of queuing up the continuity message for delivery. For example, the feedback may be a pop up screen on the display of the mobile device with the text “Message sent”. The feedback may also be in other forms of visual feedback such as change in color or font of the text, change of an image, adding an image or changing other graphical widgets. Other non-visual feedback may include an audible alarm and activation of a vibrator. In some embodiments, where a continuity marker is activated by a client, a user may or may not get a feedback about the delivery of the continuity message.

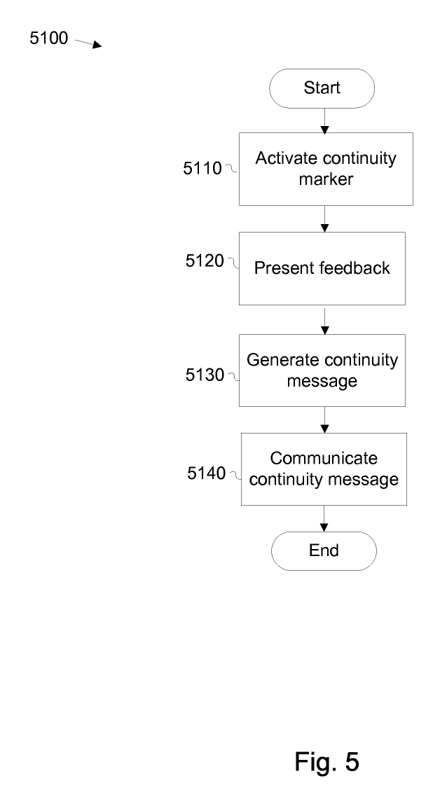

FIG. 5 illustrates an exemplary process 5100 for the generation and communication of a continuity message. Here, a user activates a continuity marker 5110 following which feedback on the activation is presented to the user on the client user interface 5120. A continuity message is then generated incorporating the identity of the activated continuity marker and associated client and user information 5130. The continuity message is then communicated to the system server 5140.

Continuation of e-commerce Transaction

Continuity messages may be received and accessed from another device in order to continue an e-commerce transaction from that device. In some embodiments, the device used to access continuity messages is a computer system such as a personal computer or a laptop computer. In some embodiments, the device used to access continuity messages may be in the form of another mobile device such as mobile phone.

A user may retrieve continuity messages communicated as email using email software such as Microsoft Outlook™ or a Web based email service. The email software or Web service retrieves the continuity message using standard protocols such as POP or IMAP. A user may retrieve the continuity messages communicated as an instant message using instant messaging software such as AOL IM™, Yahoo IM™, MSN Messenger™, Jabber or a web browser based instant messaging service. The instant messaging network interprets the continuity message as just another instant message and retrieves and presents it using its own standard or proprietary protocol.

The presentation of a continuity message may vary in different embodiments based on the communication mechanism used (e.g. email, instant message), the encoding and formatting of the continuity message (e.g., HTML) the software or service used to receive the continuity message, user preferences, the presence of multimedia data such as audio or video in the continuity message and the like. Further, if a continuity marker is present in the continuity message its presentation and activation may also be determined by various parameters such as the receiving device, user preferences and others.

User may activate hyperlinks embedded in the continuity messages to request presentation of associated hyperlinked content. The hyperlinked content may be an associated e-commerce service provided from an e-commerce server. The e-commerce service may be a shopping website, comparison shopping website, auction website and the like. The e-commerce server may or may not be part of the system server. In some embodiments, an e-commerce service from an e-commerce server may be routed though the system server. In other embodiments, the system server may not intermediate between the e-commerce service and the device where it is invoked. In some embodiments, an e-commerce server may interface with other e-commerce servers to provide an e-commerce service. The e-commerce service may be presented to the user using the user interface of the software that retrieved the continuity message or on an independent application such as a web browser.

When a user invokes an e-commerce service using the continuity message he may continue with the presented e-commerce transaction. If the e-commerce service is a shopping service, the user may be able to complete purchasing the product or service by providing appropriate information such as user identifier, credit card number, shipping information and the like. In some embodiments, the user may be able to complete shopping from an e-commerce service without providing additional information.

In a comparison shopping e-commerce service, a user may be able to browse and compare prices of products and services, and subsequently may be able to purchase from the same e-commerce service or another e-commerce service. In an auction e-commerce service, the user may be able to place a bid for purchasing a product or service or place an object for sale. In other e-commerce services, the user may be able to access and use other services and complete the e-commerce transaction.

In some embodiments, instead of completing the e-commerce transaction from the second device, the user may send the continuity message to another device to continue the transaction from that device. In some embodiments, the user may send another continuity message to the device that initiated the continuity message. For instance, a user may look up the price of a product on a mobile device while being in a shop and send a continuity message to a computer. On the computer, the user may look up various options available on different e-commerce services, and send a continuity message about a particular e-commerce service to the mobile device. Later, the user may compare the price of the product in another shop and price of the product provided by the selected e-commerce service using the continuity message on the mobile device sent from the computer. The user may then complete the e-commerce transaction on the mobile device itself.

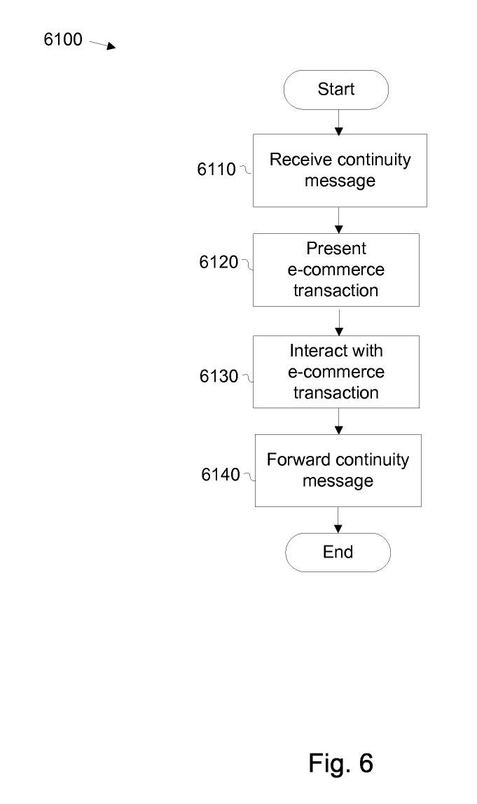

FIG. 6 illustrates an exemplary process 6100 for receiving and using a continuity message. Here, the continuity message is received by a remote computer 6110 and presented on the user interface of the remote computer 6120. Then the user can continue interacting with the e-commerce transaction communicated by the continuity message 6130. Optionally, he can also forward the continuity message to another device 6140.

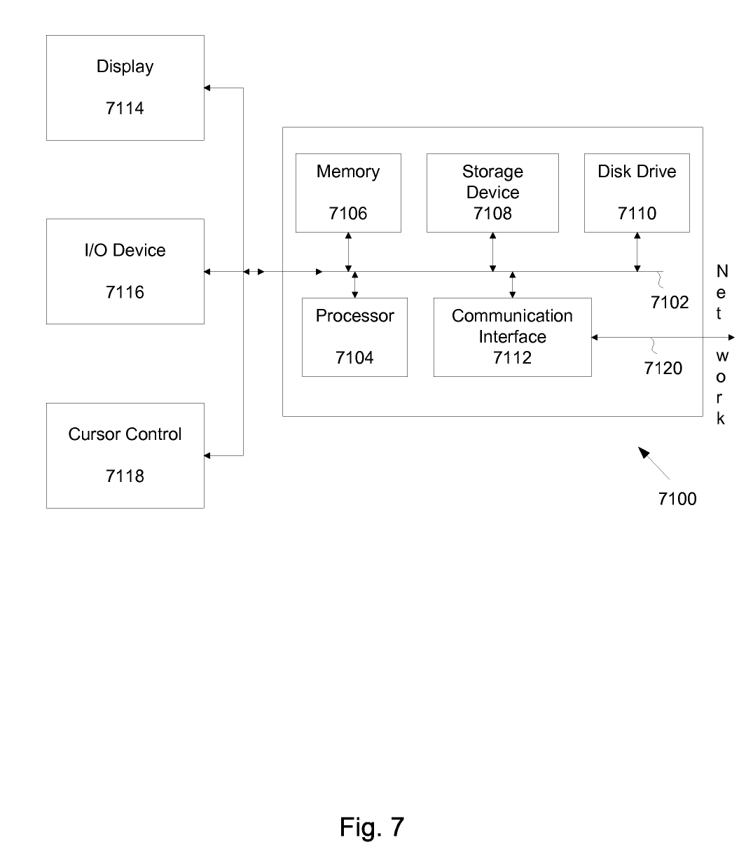

FIG. 7 is a block diagram illustrating an exemplary computer system suitable for acting as the remote computer, system server or e-commerce server. In some embodiments, computer system 7100 may be used to implement computer programs, applications, methods, or other software to perform the above described techniques for enabling continued interaction with e-commerce services.

Computer system 7100 includes a bus 7102 or other communication mechanism for communicating information, which interconnects subsystems and devices, such as processor 7104, system memory 7106 (e.g., RAM), storage device 7108 (e.g., ROM), disk drive 7110 (e.g., magnetic or optical), communication interface 7112 (e.g., modem or Ethernet card), display 7114 (e.g., CRT or LCD), input device 7116 (e.g., keyboard), and cursor control 7118 (e.g., mouse or trackball).

According to some embodiments, computer system 7100 performs specific operations by processor 7104 executing one or more sequences of one or more instructions stored in system memory 7106. Such instructions may be read into system memory 7106 from another computer readable medium, such as static storage device 7108 or disk drive 7110. In some embodiments, hard wired circuitry may be used in place of or in combination with software instructions to implement the system.

The term “computer-readable medium” refers to any medium that participates in providing instructions to processor 7104 for execution. Such a medium may take many forms, including but not limited to, nonvolatile media, volatile media, and transmission media. Nonvolatile media includes, for example, optical or magnetic disks, such as disk drive 7110. Volatile media includes dynamic memory, such as system memory 7106. Transmission media includes coaxial cables, copper wire, and fiber optics, including wires that comprise bus 7102. Transmission media may also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer may read.

In some embodiments, execution of the sequences of instructions to practice the system is performed by a single computer system 7100. According to some embodiments, two or more computer systems 7100 coupled by communication link 7120 (e.g., LAN, PSTN, or wireless network) may perform the sequence of instructions to practice the system in coordination with one another. Computer system 7100 may transmit and receive messages, data, and instructions, including program, i.e., application code, through communication link 7120 and communication interface 7112. Received program code may be executed by processor 7104 as it is received, and/or stored in disk drive 7110, or other nonvolatile storage for later execution.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A system for enabling an e-commerce transaction over a distributed network of devices comprising:
a) a mobile device; and
b) a computer system.

2. A method for enabling an e-commerce transaction over a distributed network of device including at least one of:
a) presenting a continuity marker on mobile device;
b) activating the continuity marker;
c) generating a continuity message;
d) communicating the continuity message;
e) presenting the continuity message on a remote computer system; or
f) continuing interaction with the e-commerce transaction.

3. The method recited in claim 2, the e-commerce transaction including at least one of:
a) a transaction with an online retailer;
b) a transaction with an online auction service;
c) a comparison shopping service; or
d) a accompanying financial transaction.

4. The method recited in claim 2, including presentation of the e-commerce transaction, the presentation of the e-commerce transaction including at least one of:
a) a product information;
b) a service information;
c) a review;
d) a website addresse;
e) a multimedia data; or
f) a pricing information.

5. The method recited in claim 2, wherein the presenting the continuity marker including at least one of:
a) a textual information;
b) a graphical information; or
c) a audio information.

6. The method recited in claim 2, wherein the activating the continuity marker including at least one of:
a) a user initiated activation; or
b) a system initiated activation.

7. The method recited in claim 2, wherein the communicating the continuity message including at least one of:
a) a communication directly to the recipient;
b) a communication to the recipient through the system server;
c) a use of SMS;
d) a use of MMS;
e) a use of email;
f) a use of instant messaging;
g) a use of TCP/IP; or
h) a use of HTTP.

8. The method recited in claim 2, wherein the continuing the e-commerce transaction including at least one of:
a) a presentation of the continuity message;
b) a user interaction with the continuity message;
c) a initiation of a financial transaction;
d) a initiation of a auction bid; or
e) a communication of the continuity message.
